(19) United States
(12) Patent Application Publication
(10) Pub. No.: US 2008/0212690 A1
(43) Pub. Date: Sep. 4, 2008

(54) TRANSCODER MEDIA TIME CONVERSION

(75) Inventor: Serafim S. Loukas, Carlsbad, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/961,955

(22) Filed: Dec. 20, 2007

Related U.S. Application Data
(60) Provisional application No. 60/892,522, filed on Mar. 1, 2007.

(51) Int. Cl. H04N 7/26

(52) U.S. Cl. 375/240.28; 375/E07.198

(57) ABSTRACT

In general, this disclosure describes techniques of compensating for differences between a clock associated with an input stream of media data and a clock associated with an output stream of media data. Due to drift between a clock that governs the rate at which a transcoder receives media data units (“MDUs”) and a clock that governs the rate at which the transcoder outputs MDUs, the transcoder may receive MDUs at a rate that is faster or slower than a rate at which the transcoder outputs the MDUs. The transcoder compensates for such differences by identifying sets of received MDUs that account for a time equal to an output period minus a correction magnitude, modifying the identified sets of MDUs such that the sets of MDUs account for a time equal to the output period, and outputting the modified sets of MDUs as part of the output stream.

### CLAIM OF PRIORITY

This application claims the benefit of U.S. Provisional Application No. 60/892,522, filed Mar. 1, 2007, the entire content of which is hereby incorporated by reference.

### TECHNICAL FIELD

The disclosure is directed to multimedia signal processing and, more particularly, to video encoding and decoding.

### BACKGROUND

Digital multimedia capabilities can be incorporated into a wide range of devices, including digital televisions, digital direct broadcast systems, wireless communication devices, wireless broadcast systems, personal digital assistants (PDAs), laptop or desktop computers, digital cameras, digital recording devices, video gaming devices, video game consoles, cellular or satellite radio telephones, and the like. Digital multimedia devices may implement video coding techniques, such as MPEG-2, MPEG-4, or H.264/MPEG-4, Part 10, Advanced Video Coding (AVC), to transmit and receive digital video data more efficiently. Video coding techniques may perform video compression via spatial and temporal prediction to reduce or remove redundancy inherent in video sequences.

Media content distributors, such as cable and satellite television services, receive multimedia content from a variety of sources. These sources may include television stations, radio stations, and other original multimedia content providers. Media content distributors may produce or redistribute the original multimedia to other devices, such as those used by the final consumer. Prior to this re-distribution the multimedia data may be reformatted or converted from the input format to another format such as a wireless format. This process is usually referred to as “transcoding” and is accomplished by a processing element referred to as a transcoder or transcoder device. The input stream of multimedia data is formatted and transported in a variety of ways. For example, the input stream may be formatted as a Moving Pictures Experts Group transport stream (MPEG-TS) and transported over a synchronous serial interface (ASI). In another example, the input stream may be may be formatted and transported using the serial digital interface (SDI).

A multimedia content distributor may want to transmit the multimedia data to mobile wireless subscriber devices (such as mobile handsets or so-called multimedia “cell phones”) using multimedia broadcasting techniques. For example, multimedia broadcasting techniques include those referred to as Forward Link Only (FLO), Digital Multimedia Broadcasting (DMB), and Digital Video Broadcasting-Handheld (DVB-H). Wireless digital multimedia broadcasting may deliver multimedia content to many subscriber devices as a series of broadcast channels, providing a multimedia content selection experience similar to that of a conventional television. Each broadcast channel carries digital data comprising encoded audio/video streams, audio/video clips, or other informational content. The digital broadcast channels are delivered simultaneously on a multicast basis to multiple mobile wireless subscriber devices. Users of mobile wireless subscriber devices that receive the digital broadcast may individually tune their subscriber devices to one or more of the broadcast channels. When a user of a mobile wireless subscriber device tunes his or her mobile wireless subscriber device to a particular broadcast channel, the mobile wireless subscriber device presents multimedia data in the particular broadcast channel to the user.

### SUMMARY

In general, this disclosure describes techniques of compensating for small differences between a clock associated with an input stream of media data and a clock associated with an output stream of media data. Due to drift between a clock that governs the rate at which a transcoder receives media data units (“MDUs”) and a clock that governs the rate at which the transcoder outputs MDUs, the transcoder may receive MDUs at a rate that is faster or slower than a rate at which the transcoder outputs the MDUs. The transcoder compensates for such differences by identifying sets of received MDUs that account for a time equal to an output period minus a correction magnitude, modifying the identified sets of MDUs such that the sets of MDUs account for a time equal to the output period, and outputting the modified sets of MDUs as part of the output stream.

This disclosure may involve collecting the time drift error, and continuously performing content gap detection, e.g., by examining and processing the input multi-media data. Once a gap is detected, this disclosure may involve correcting the entire error accumulated to that point. The time correction and conversion may use the detection of content gaps in the input multi-media data in order to avoid content disruptions. Modifications to the MDUs may be used to adjust for timing, and therefore, by identifying content gaps in the input multimedia data, such adjustments may be transparent to the final consumers that receive transcoded content.

In one example, a method comprises storing a plurality of media data units MDUs into a buffer of a transcoder at a rate that is dependent upon a source clock of a media source, identifying an output interval for a set of the MDUs in the buffer, wherein the output interval is dependent upon the source clock and differs from an output period by a correction magnitude, wherein the output period is dependent upon an output clock of the transcoder, removing the set of the MDUs from the buffer, wherein an amount of time associated with the removed set of the MDUs substantially corresponds the output interval, and modifying the set of the MDUs removed from the buffer based on content of the MDUs such that an amount of time associated with the modified set of MDUs substantially corresponds to the output period. As discussed in greater detail below, the modification to the set of MDUs may be based on content of the MDUs.

In another example, this disclosure provides a transcoder device comprising an output clock, a buffer capable of storing media data units MDUs, a receiving module that stores the MDUs into the buffer at a rate that is dependent upon a source clock of a media source, an interval identification module that identifies an output interval for a set of the MDUs in the buffer, wherein the output interval is dependent upon the source clock differs from an output period by a correction magnitude, wherein the output period is dependent upon the output clock of the transcoder device, an MDU removal module that removes the set of MDUs from the buffer, wherein an amount of time associated with the removed set of the MDUs substantially corresponds to the output interval, and a drift correction module that modifies the set of MDUs removed from the buffer based on content of the MDUs such that an amount of time associated with the modified set the MDUs substantially corresponds to the output period.

In another example, this disclosure provides a transcoder device comprising means for storing a plurality of media data units MDUs into a buffer at a rate that is dependent upon a source clock of a media source, means for identifying an output interval for a set of the MDUs in the buffer, wherein the output interval is dependent upon the source clock and differs from an output period by a correction magnitude, wherein the output period is dependent upon an output clock of the transcoder, means for removing the set of the MDUs from the buffer, wherein an amount of time associated with the removed set of the MDUs substantially corresponds the output interval, and means for modifying the set of the MDUs removed from the buffer based on content of the MDUs such that an amount of time associated with the modified set of MDUs substantially corresponds to the output period.

The techniques described in this disclosure may be implemented in hardware, software, firmware, or any combination thereof. If implemented in software, the software may be executed using one or more processors, such as a microprocessor, application specific integrated circuit (ASIC), field programmable gate array (FPGA), or digital signal processor (DSP). The software that executes the techniques may be initially stored in a computer-readable medium and loaded and executed using the one or more processors.

Accordingly, this disclosure also contemplates a computer-readable medium that comprises executable instructions. The instructions upon execution cause one or more processors to store a plurality of media data units MDUs into a buffer of a transcoder at a rate that is dependent upon a source clock of a media source, identify an output interval for a set of the MDUs in the buffer, wherein the output interval is dependent upon the source clock and differs from an output period by a correction magnitude, wherein the output period is dependent upon an output clock of the transcoder, remove the set of the MDUs from the buffer, wherein an amount of time associated with the removed set of the MDUs substantially corresponds the output interval, and modify the set of the MDUs removed from the buffer based on content of the MDUs such that an amount of time associated with the modified set of MDUs substantially corresponds to the output period.

In some cases, the computer-readable medium may form at least part of a computer program product, which may be sold and/or used in a video coding device. The computer program product may include the computer-readable medium, and in some cases, may also include packaging materials.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an exemplary media distribution system.

FIG. 2 is a block diagram illustrating exemplary details of a transcoder.

FIG. 3 is a block diagram illustrating exemplary details of a time conversion module in the transcoder.

FIG. 4 is a flowchart illustrating an exemplary operation of the time conversion module.

FIG. 5 is a flowchart illustrating an exemplary calibration operation performed by a calibration module in the time conversion module.

FIG. 6 is a flowchart illustrating an exemplary post-calibration operation of post-calibration module in the time conversion module.

### DETAILED DESCRIPTION

This disclosure describes techniques of compensating for small differences between a clock associated with an input stream of media data and a clock associated with an output stream of media data. Due to drift between a clock that governs the rate at which a transcoder receives media data units (“MDUs”) and a clock that governs the rate at which the transcoder outputs MDUs, the transcoder may receive MDUs at a rate that is faster or slower than a rate at which the transcoder outputs the MDUs. The transcoder compensates for such differences by identifying sets of received MDUs that account for a time equal to an output period minus a correction magnitude, modifying the identified sets of MDUs such that the sets of MDUs account for a time equal to the output period. As described in greater detail below, the modifications to the MDUs may be based on content of the MDUs to reduce or eliminate any perceivable changes to the content when it is presented to the end consumer.

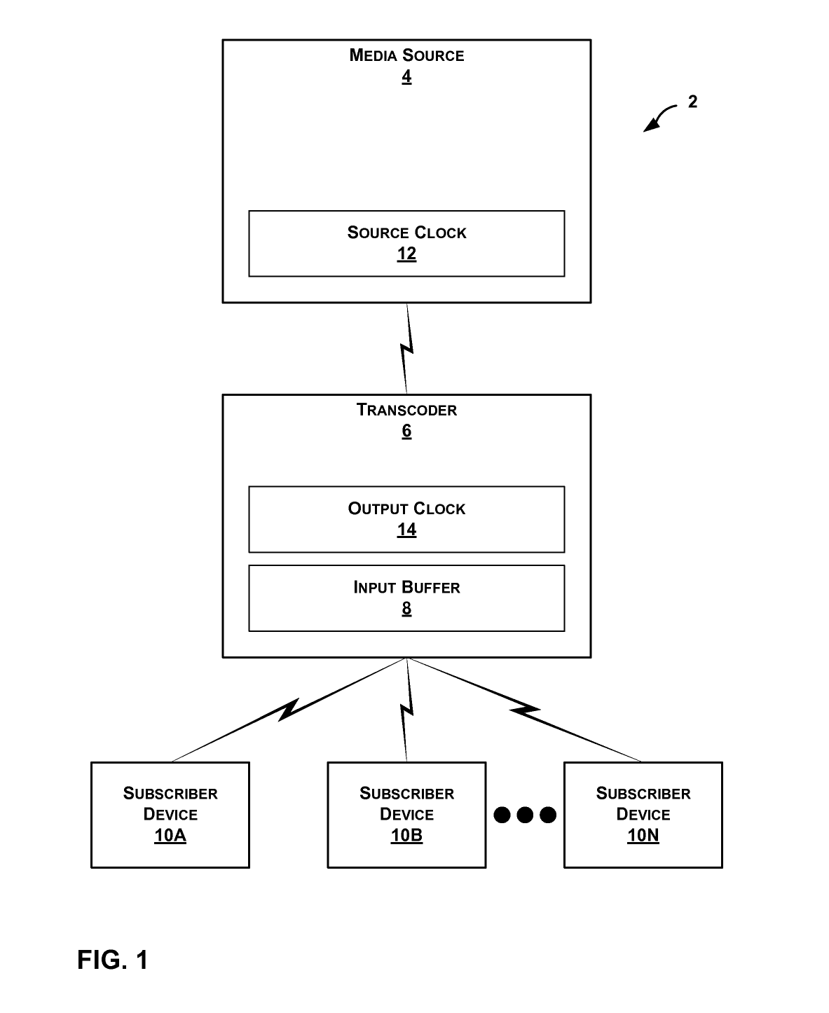

FIG. 1 is a block diagram illustrating an exemplary media distribution system 2. Media distribution system 2 in an example of a media distribution system in which a media source 4 provides a stream of multimedia data to a transcoder 6. Transcoder 6 modifies the stream of multimedia data and uses wireless multimedia broadcasting techniques to transmit multimedia content to multiple subscriber devices 10A-10N (collectively, “subscriber devices 10”). For example, transcoder 6 may use wireless multimedia broadcasting techniques that include those referred to as Forward Link Only (FLO), Digital Multimedia Broadcasting (DMB), and Digital Video Broadcasting-Handheld (DVB-H).

Media distribution system 2 is merely exemplary as many other systems could also make use of the techniques described herein. The techniques of this disclosure may be particularly useful to broadcast systems, but could also apply to systems that support two-way wireless communication of multimedia information, such as systems that support video telephony or other systems that support video coding and communication of video information. Nevertheless, although the techniques of this disclosure are primarily described as being used in a wireless system, other systems (including wired communication systems) may also benefit from the techniques described herein.

In media distribution system 2, media source 4 provides media content via one or more wired or wireless links. For example, media source 4 may be a satellite that transmits encoded television programs, video clips, movies, advertisement messages, streaming audio, video feeds, video teleconference data, and other media content. In another example, media source 4 may be a transmission unit for a cable television service. The stream of media data supplied by media source 4 and the stream of media data generated by transcoder 6 include media data units (“MDUs”). As used in this disclosure, a “media data unit” may refer to a video frame, an audio sample, or another type and quantity of media data.

In media distribution system 2, a transcoder 6 receives a stream of media data from media source 4. For example, transcoder 6 may receive a Moving Pictures Expert Group-2 (MPEG-2) transport stream from media source 4. When transcoder 6 receives the stream of media data, transcoder 6 may temporarily store in an input buffer 8 MDUs based on MDUs in the stream of media data. Transcoder 6 may then remove MDUs from input buffer 8, modify the removed MDUs, and output the modified MDUs as a stream of media data via one or more wired or wireless links. As examples, transcoder 6 may output the modified MDUs using one or more radio broadcast technologies such as FLO, DMB, or DVB-H, or according to one or more radio access technologies, such as Global System for Mobile Communications (GSM), code division multiple access (CMDA), CDMA 2000, wideband CDMA (W-CDMA), CDMA 1× Evolution-Data Optimized (EV-DO), frequency division multiple access (FDMA), orthogonal frequency division multiplexing (OFDM), time division multiple access (TDMA) or the broad family of standards developed to facilitate wireless networking defined by the various IEEE 801.xx standards, or other wireless or wired communication standards.

In some aspects, the techniques described in this disclosure may be applied to Enhanced H.264 video coding for delivering real-time video services in terrestrial mobile multimedia multicast (TM3) systems using the FLO Air Interface Specification, “Forward Link Only Air Interface Specification for Terrestrial Mobile Multimedia Multicast,” to be published as Technical Standard TIA-1099 (the “FLO Specification”). That is to say, transcoder 6 may broadcast wireless video information according to the FLO Specification, or the like. The FLO Specification includes examples defining bitstream syntax and semantics and decoding processes suitable for the FLO Air Interface. Alternatively, video may be broadcasted according to other standards such as DVB-H (digital video broadcast-handheld), ISDB-T (integrated services digital broadcast-terrestrial), or DMB (digital media broadcast).

Subscriber devices 10 may receive the modified stream of media data generated by transcoder 6. When subscriber devices 10 receive the modified stream of media data, subscriber devices 10 may decode the modified stream of media data and present the decoded media data. For example, the modified stream of media data may represent a television program. In this example, subscriber devices 10 may display the television program. Subscriber devices 10 may be a wide variety of devices. For example, subscriber devices 10 may be mobile radiotelephones, digital televisions, personal digital assistants, devices integrated into vehicles (e.g., cars, motorcycles, airplanes, spacecraft, trucks, trains, buses, etc.), video game systems, laptop computers, tablet computers, personal computers, television set-top boxes, personal media players, theatre systems, digital signage, and other types of devices.

Media source 4 outputs MDUs at a rate governed by a source clock, e.g. source clock 12 of media source 4. For example, media source 4 may output video frames at a rate of 30 video frames per second, as measured by source clock 12. Furthermore, transcoder 6 outputs MDUs at a rate governed by an output clock 14. For instance, transcoder 6 may output video frames at a rate of 30 video frames per second, as measured by output clock 14. If source 12 clock and output clock 14 are precisely synchronous (i.e., neither clock “ticks” faster than the other), transcoder 6 receives MDUs from media source 4 at the same rate that transcoder 6 outputs MDUs to subscriber devices 10.

However, source clock 12 and output clock 14 might not be precisely synchronous. When source clock 12 is too fast relative to output clock 14, transcoder 6 may receive MDUs from media source 4 at a rate that is faster than a rate at which transcoder 6 outputs MDUs. If left uncorrected, the number of MDUs in input buffer 8 may increase to a point at which input buffer 8 cannot store any more unsent MDUs (i.e., an overflow point). This may result in a loss of MDUs. Similarly, when source clock 12 is too slow relative to output clock 14, transcoder 6 may receive MDUs from media source 4 at a rate that is slower than the rate at which transcoder 6 outputs MDUs. If left uncorrected, the number of MDUs in input buffer 8 may decrease to a point at which there are not enough MDUs stored in input buffer 8 to send (i.e., an underflow point). This may result in a gap in the output stream. In either scenario, users of subscriber devices 10 may be able to perceive this loss of MDUs or this gap. This may be disruptive to the users' experiences.

As part of an operation to compensate for drift between the source clock and the output clock, transcoder 6 may move through a series of distinct phases. When transcoder 6 initially begins to receive an input stream from media source 4, transcoder 6 may be in a “buffer fill” phase. During the “buffer fill” phase, transcoder 6 may store MDUs from media source 4 in input buffer 8 without outputting MDUs to subscriber devices 10. Furthermore, during the “buffer fill” phase, transcoder 6 may continue to store MDUs from media source 4 in input buffer 8 without outputting MDUs to subscriber devices 10 until input buffer 8 stores a sufficient minimum number of MDUs. When input buffer 8 stores a sufficient minimum number of MDUs, the “buffer fill” phase may end and a calibration phase may begin. This sufficient minimum number may be defined by the implementation, but is generally a number of MDUs sufficient to facilitate measurements and adjustments as described herein.

During the calibration phase, transcoder 6 receives MDUs from media source 4 and temporarily stores the received MDUs in input buffer 8. Furthermore, during a calibration phase, transcoder 6 may perform a calibration operation each time output clock determines that an output interval has passed. This output interval may be a time equal to one second or another period of time. Alternatively, the output interval may be defined based on a number of samples. During a calibration operation, transcoder 6 may remove from input buffer 8 a set of the oldest MDUs in input buffer 8. The oldest MDUs may be defined by the order that the MDUs are received. This set of MDUs accounts for a time equal to one output period, as measured by the output clock. In other words, the removed MDUs would be played back in one output period, as measured by the output clock. After removing the set of MDUs from input buffer 8, transcoder 6 may output MDUs based on the removed set of MDUs. Furthermore, when transcoder 6 performs the calibration operation, transcoder 6 may calculate an average depth of input buffer 8. As used in this disclosure, the “depth” of input buffer 8 refers to the length of time, as measured by the output clock, between an “oldest” MDU in input buffer 8 and a “newest” MDU in input buffer 8. The oldest and newest MDUs may be defined according to when the MDUs are received in input buffer 8, e.g., according to a first-in-first-out (FIFO) technique. The “oldest” MDU in input buffer 8 is the MDU in input buffer 8 that is to be presented before any other MDU in input buffer 8. The “newest” MDU in input buffer 8 is the MDU in input buffer 8 that is to be presented after all other MDUs in input buffer 8.

At the end of this calibration operation, transcoder 6 may determine whether the average depth of input buffer 8 is stable. Transcoder 6 may determine that the average depth of input buffer 8 is stable when the average depth of input buffer 8 has not changed by more than a certain percentage within a particular period of time. If the average depth of input buffer 8 is stable, transcoder 6 may establish a setpoint at the average depth of input buffer 8 and the calibration phase is complete.

After the calibration phase is complete, transcoder 6 may continue to receive MDUs from media source 4 and may continue to store the received MDUs in input buffer 8. Furthermore, after the calibration phase is complete, transcoder 6 performs a post-calibration operation each time the output clock determines that the output period has passed. As part of a post-calibration operation, transcoder 6 may identify a correction magnitude. As described in detail below, transcoder 6 may identify the correction magnitude based on a drift factor that is at least approximately equal to the setpoint minus a current depth of input buffer 8. After identifying the correction magnitude, transcoder 6 may remove from input buffer 8 a set of the oldest MDUs. This removed set of MDUs accounts for an amount of time equal to one output interval, which may also correspond to one output period minus the identified correction magnitude. After removing the set of MDUs from input buffer 8, transcoder 6 may modify the removed set of MDUs such that the modified set of MDUs correspond to an amount of time equal to one output period. Transcoder 6 may modify the removed set of MDUs by performing one or more operations that modify times between existing MDUs in the removed set of MDUs or selectively deleting MDUs in the removed set of MDUs. Furthermore, these adjustments to the MDUs may be based on content so that content disruptions are avoided to the end consumers that operation subscriber devices 10.

Transcoder 6 may then output one of the sets of MDUs each time the output clock indicates that one output period has passed. For example, transcoder 6 may generate a stream of multimedia data and then modulate the stream of multimedia data according to a wireless physical layer modulation scheme. For example, transcoder 6 may modulate the stream of multiplexed multimedia data according to one or more radio broadcast technologies such as Forward Link Only (“FLO”), Digital Multimedia Broadcasting (“DMB”), or Digital Video Broadcasting-Handheld (“DVB-H”), or according to one or more radio access technologies, such as Global System for Mobile Communications (“GSM”), code division multiple access (“CMDA”), CDMA 2000, wideband CDMA (“W-CDMA”), CDMA 1× Evolution-Data Optimized (“EV-DO”), frequency division multiple access (“FDMA”), orthogonal frequency division multiplexing (“OFDM”), time division multiple access (“TDMA”) or the broad family of standards developed to facilitate wireless networking defined by the various IEEE 801.11x standards. Transcoder 6 may then transmit the modulated stream of multimedia data to subscriber devices 10.

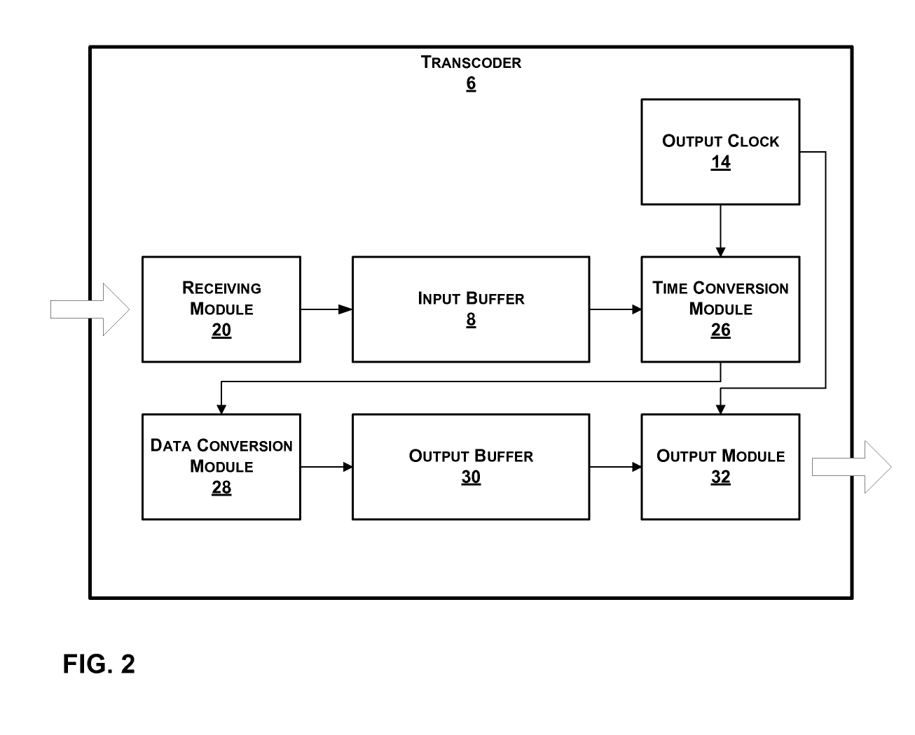

FIG. 2 is a block diagram illustrating exemplary details of transcoder 6. As illustrated in the example of FIG. 2, transcoder 6 includes a receiving module 20. Receiving module 20 receives MDUs from media source 4. When receiving module 20 receives an MDU, receiving module 20 adds the MDU to input buffer 8. In some instances, receiving module 20 may receive encoded MDUs that are included in a stream of multimedia data. In these instances, receiving module 20 may decode the encoded MDUs prior to adding the MDUs into input buffer 8.

An output clock 14 in transcoder 6 indicates that an output period has passed by outputting a pulse. For example, when the output period is one second, output clock 14 may indicate that one second has passed by outputting a pulse after one second has passed. Output clock 14 may be synchronized to the Global Positioning System (“GPS”) or other highly accurate timekeeping system (not shown). For example, output clock 14 may receive signals from orbiting GPS satellites and may use these signals to accurately determine the current time. In another example, output clock 14 may be synchronized by receiving messages from other devices (not shown) that are synchronized to the GPS. As a result of being synchronized with the GPS or other accurate timekeeping system, output clock 14 may be very accurate.

When a time conversion module 26 in transcoder 6 receives a pulse from output clock 14, time conversion module 26 may determine whether transcoder 6 is in a “buffer fill” phase. Transcoder 6 may be in the “buffer fill” phase when transcoder 6 initially starts receiving a stream of media data from media source 4. Time conversion module 26 may determine that transcoder 6 is in the “buffer fill” phase when a flag indicates that transcoder 6 is in the “buffer fill” phase, or by some other measure of buffer fullness or depth.

When time conversion module 26 determines that transcoder 6 is in the “buffer fill” phase, time conversion module 26 measures the “depth” of input buffer 8. As used in this disclosure, the “depth” of input buffer 8 refers to the length of time, as measured by output clock 14, between an “oldest” MDU in input buffer 8 and a “newest” MDU in input buffer 8. The “oldest” MDU in input buffer 8 is the MDU in input buffer 8 that is to be presented before any other MDU in input buffer 8. The “newest” MDU in input buffer 8 is the MDU in input buffer 8 that is to be presented after all other MDUs in input buffer 8. In one example, the “depth” of input buffer 8 may comprise a measure of how many seconds worth of MDUs are presently stored in input buffer 8, as measured by output clock 14.

Furthermore, during the “buffer fill” phase, time conversion module 26 determines whether the average depth of input buffer 8 is greater than or equal to a minimum buffer depth. For example, the minimum buffer depth may be two full output periods (e.g., two seconds) the length of time between an oldest MDU in input buffer 8 and the newest MDU in input buffer 8 is two seconds, as measured by output clock 14). If time conversion module 26 determines that the average depth of input buffer 8 is not greater than or equal to (i.e., is less than) the minimum buffer depth, time conversion module 26 may wait until the next pulse from output clock 14. On the other hand, if time conversion module 26 determines that the average depth of input buffer 8 is greater than or equal to the minimum buffer depth, time conversion module 26 may set a flag to indicate that the “buffer fill” phase is complete.

If, after receiving a pulse from output clock 14, time conversion module 26 determines that transcoder 6 is not in the “buffer fill” phase, time conversion module 26 may determine whether transcoder 6 is in a calibration phase. Time conversion module 26 may determine that transcoder 6 is in a calibration phase by determining whether a flag indicates that transcoder 6 is in a calibration phase, or by another means. If time conversion module 26 determines that transcoder 6 is in the calibration phase, time conversion module 26 may perform a calibration operation. As explained in detail below, each time that time conversion module 26 performs a calibration operation, time conversion module 26 calculates an average depth of input buffer 8 and removes one output period's worth of MDUs from input buffer 8. When time conversion module 26 determines that the average depth of input buffer 8 is stable, the calibration phase is complete and a setpoint is set to the average depth of input buffer 8. Time conversion module 26 then provides the removed MDUs to a data conversion module 28.

On the other hand, if time conversion module 26 determines that transcoder 6 is not in the “buffer fill” phase or in the calibration phase when time conversion module 26 receives a pulse from output clock 14, time conversion module 26 performs a post-calibration operation. As explained in detail below, during a post-calibration operation, time conversion module 26 identifies output intervals for sets of MDUs in input buffer 8. Furthermore, time conversion module 26 removes sets of MDUs from input buffer 8. The sets of MDUs removed from input buffer 8 correspond to amounts of time substantially equal to the output intervals that have been identified for respective ones of the sets of MDUs. In addition, during the post-calibration operation, time conversion module 26 may modify one or more of the sets of MDUs that account for amounts of time that are not substantially equal to the output period. Time conversion module 26 may modify the sets of MDUs by modifying times between MDUs within the ones of the sets of MDUs or by selectively adding or deleting one or more MDUs within the ones of the sets of MDUs in order to cause the modified sets of MDUs to correspond to the correct output period. After performing any such modifications, time conversion module 26 may provide the sets of MDUs, modified or unmodified, to data conversion module 28. Once time conversion module 26 completes a post-calibration operation, time conversion module 26 may wait for the next pulse from output clock 14.

When data conversion module 28 receives a set of MDUs from time conversion module 26, data conversion module 28 may convert the media data in the MDUs from a first format to a second format to effectively “transcode” the data. For example, data conversion module 28 may convert the media data in the MDUs from MPEG-2 data to data used in the MediaFLO™ system promulgated by QUALCOMM Incorporated of San Diego, Calif. In another example, data conversion module 28 may convert the media data in the MDUs from a serial digital interface format (e.g., American National Standards Institute/Society of Motion Picture and Television Engineers (“ANSI/SMPTE”) Serial Digital Interface 259M, 125M, 272M, etc.) to another format. Data conversion module 28 may convert the set of MDUs from the first format to the second format in a fixed period of time. After data conversion module 28 converts the set of MDUs from the first format to the second format, data conversion module 28 may add the converted MDUs into an output buffer 30.

It should be further noted that data conversion module 28 may also convert the MDUs prior to their entry into input buffer 8. In this scenario, time conversion module 26 may output the modified set of MDUs directly to output buffer 30.

When an output module 32 receives a pulse from output clock 14, output module 32 may identify one-output period's worth of the oldest MDUs in output buffer 30. After identifying the MDUs, output module 32 may remove the identified MDUs from output buffer 30. Output module 32 may then transmit the removed MDUs to subscriber devices 10 as part of an output stream. In other implementations, output buffer 32 and input buffer 8 may be separate storage spaces within a common memory, or possibly a common storage space within memory.

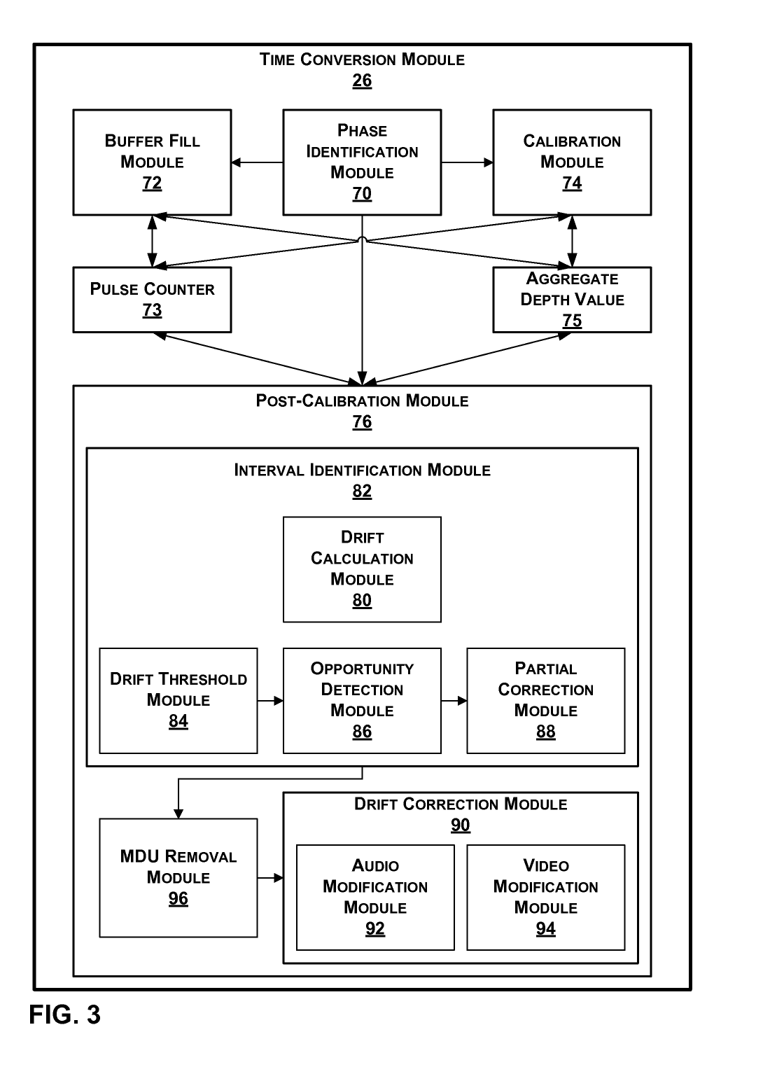

FIG. 3 is a block diagram illustrating exemplary details of time conversion module 26 in transcoder 6. As illustrated in the example of FIG. 3, time conversion module 26 comprises a phase identification module 70. Phase identification module 70 may receive a pulse from output clock 14 once every output period. When phase identification module 70 receives a pulse from output clock 14, phase identification module 70 identifies a current phase of transcoder 6. If phase identification module 70 identifies the “buffer fill” stage as the current phase of transcoder 6, phase identification module 70 may instruct a buffer fill module 72 in time conversion module 26 to perform a “buffer fill” operation. If phase identification module 70 identifies the calibration phase as the current phase of transcoder 6, phase identification module 70 may instruct a calibration module 74 to perform a calibration operation. Otherwise, if phase identification module 70 identifies a post-calibration phase as the current phase of transcoder 6, phase identification module 70 may instruct a post-calibration module 76 to perform a post-calibration operation.

When phase identification module 70 instructs buffer fill module 72 to perform a “buffer fill” operation, buffer fill module 72 may measure the average depth of input buffer 8. In order to measure the average depth of input buffer 8, buffer fill module 72 may, for example, maintain a pulse counter 73 that indicates how many output periods, as measured by output clock 14, have passed since the beginning of the “buffer fill” phase. In addition, buffer fill module 72 may maintain an aggregate depth value 75 that represents a sum of all measured depths of input buffer 8 during the “buffer fill” phase. In this example, buffer fill module 72 may calculate the average depth of input buffer 8 by measuring a current depth of input buffer 8, adding the current depth of input buffer 8 to aggregate depth value 75, and dividing this sum by pulse counter 73. Calculating the average depth of input buffer 8 in this way may minimize temporary effects due to jitter.

After buffer fill module 72 calculates the average depth of input buffer 8, buffer fill module 72 may then determine whether the average depth of input buffer 8 is greater than or equal to a minimum buffer depth. If buffer fill module 72 determines that the average depth of input buffer 8 is greater than or equal to the minimum buffer depth, buffer fill module 72 may set a flag to indicate that the “buffer fill” phase is complete. Otherwise, if buffer fill module 72 determines that the average depth of input buffer 8 is not greater than or equal to (i.e., is less than) the minimum buffer depth, buffer fill module 72 performs no further action. In this way, buffer fill module 72 may ensure that input buffer 8 contains a sufficient number of MDUs before other modules in time conversion module 26 begin removing MDUs from input buffer 8.

When phase identification module 70 instructs calibration module 74 to perform a calibration operation, calibration module 74 performs a calibration operation. As part of the calibration operation, calibration module 74 may increment pulse counter 73. After incrementing pulse counter 73, calibration module 74 may measure the current depth of input buffer 8. Calibration module 74 may then add the current depth of input buffer 8 to aggregate depth value 75. Next, calibration module 74 may calculate an average depth of input buffer 8 by dividing aggregate depth value 75 by pulse counter 73.

After calculating the average depth of input buffer 8, calibration module 74 may determine whether the average depth of input buffer 8 is stable. Calibration module 74 may determine that the average depth is stable when the average depth has not changed by a significant amount for a given period of time. For example, if the average depth has not changed by more than one microsecond in sixty seconds, calibration module 74 may determine that the average depth is stable.

If calibration module 74 determines that the average depth is stable, calibration module 74 may establish a setpoint equal at the average depth. In this way, the setpoint is a measure of the average depth of input buffer 8 during the calibration phase. Calibration module 74 may then set a flag to indicate that the calibration phase is complete. Because the calibration phase is now complete, the setpoint is established (i.e., “set”) at the value at which the average depth is “stable.” Again, the average depth of input buffer 8 may be determined to be stable if it has not changed by more than a certain (e.g., pre-defined) percentage within a particular period of time.

On the other hand, if calibration module 74 determines that the average depth is not stable (e.g., determines that the average depth has changed by a significant amount within the given period of time), calibration module 74 does not establish the setpoint at the average depth and does not set the flag to indicate that the calibration phase is complete. Consequently, the calibration phase is not complete and transcoder 6 remains in the calibration phase.

Next, calibration module 74 may remove from input buffer 8 one output period's worth of the oldest MDUs in input buffer 8, as measured by output clock 14. For example, if it takes one output period, as measured by output clock 14, to display fifty MDUs, then time conversion module 26 removes the fifty oldest MDUs in input buffer 8. After calibration module 74 removes these MDUs from input buffer 8, calibration module 74 may provide these MDUs to data conversion module 28.

When phase identification module 70 instructs post-calibration module 76 to perform a post-calibration operation, post-calibration module 76 performs the post-calibration operation. In order to perform a post-calibration operation, an interval identification module 82 in post-calibration module 76 identifies an output interval. In the example of FIG. 3, interval identification module 82 includes a drift calculation module 80 that calculates a drift factor. Drift calculation module 80 may calculate the drift factor by incrementing pulse counter 73. Drift calculation module 80 may then update aggregate depth value 75 by measuring a current depth of input buffer 8 and adding the measured depth of input buffer 8 to aggregate depth value 75. Next, drift calculation module 80 may calculate an average depth of input buffer 8 by calculating the quotient of aggregate depth value 75 over pulse counter 73 (e.g., drift calculation module 80 may divide aggregate depth value 75 by pulse counter 73). Drift calculation module 80 may then calculate the drift factor by subtracting the average depth from the setpoint.

As discussed above, when the clock of media source 4 (i.e., the source clock 12) is perfectly accurate, transcoder 6 receives one output period's worth of MDUs from media source 4 every output period, as measured by output clock. However, if the source clock is fast relative to output clock 14, then media source 4 provides more than one output period's worth of MDUs to transcoder 6 every output period (as measured by output clock 14). Without drift compensation, transcoder 6 outputs one output period's worth of MDUs every output period. Consequently, transcoder 6 is receiving more MDUs from media source 4 in one output period than transcoder 6 is outputting in one output period. For this reason, over time, MDUs in input buffer 8 tend to increase in number when the source clock is too fast relative to output clock 14. This increase is reflected by a negative drift factor when the current average depth of input buffer 8 is subtracted from the stable setpoint. Similarly, if source clock 12 is slow relative to output clock 14, then media source 4 provides less than one output period's worth of MDUs to transcoder 6 every output period (as measured by output clock 14).

Without drift compensation, transcoder 6 outputs one output period's worth of MDUs every output period. Consequently, transcoder 6 is receiving fewer MDUs from media source 4 in one output period than transcoder 6 is outputting in one output period. For this reason, over time, MDUs in input buffer 8 tend to decline in number when the source clock is too slow relative to output clock 14. This decline is reflected by a positive drift factor when the current average depth of input buffer 8 is subtracted from the stable setpoint.

After drift calculation module 80 calculates the drift factor, a drift threshold module 84 in interval identification module 82 may determine whether the absolute value of the drift factor is greater than or equal to a minimum drift threshold. The minimum drift threshold is a value (i.e., absolute value) that indicates a minimum amount of drift before a drift correction can be performed. For example, the minimum drift threshold may be equal to thirty milliseconds. If drift threshold module 84 determines that the absolute value of the drift factor is not greater than or equal to (i.e., is less than) the minimum drift threshold, drift threshold module 84 may identify the correction magnitude as zero. Drift threshold module 84 may then calculate the output interval by subtracting the identified correction magnitude from one output period. Because the output interval is equal to one output period minus the correction magnitude, drift threshold module 84, in this scenario, identifies an output interval of one output period. In this way, post-calibration module 76 does not attempt to compensate for drift when only a small amount of drift has accumulated.

Otherwise, if drift threshold module 84 determines that the absolute value of the drift factor is greater than or equal to the minimum drift correction time, an opportunity detection module 86 in interval identification module 82 may determine whether a set of the oldest MDUs in input buffer 8 that account for an amount of time equal to one output period is associated with a “correction opportunity.” As used in this disclosure, the term “correction opportunity” refers to a set of MDUs within a stream of media data in which a user would not be able to notice a drift correction.

Correction opportunities may be defined by the actual content of the MDUs. For example, the oldest MDU in input buffer 8 may represent a correction opportunity when the oldest set of MDUs are not associated with references to a program clock reference, when MDUs in the oldest set of MDUs are associated with discontinuous program clock references, when MDUs in the oldest set of MDUs are associated with different program map tables, when one or more consecutive MDUs correspond to audio silence and/or dark or no video, or when one or more MDUs in the oldest set of MDUs are associated with program map table revision messages. If opportunity detection module 86 determines that the oldest set of MDUs is associated with a correction opportunity, opportunity detection module 86 may identify the correction magnitude as the drift factor. Opportunity detection module 86 may then calculate the output interval by subtracting the identified correction magnitude from one output period minus the drift factor. In this way, post-calibration module 76 compensates for all of the accumulated drift when a user would not be able to notice a drift correction.

When opportunity detection module 86 determines that the oldest set of MDUs does not represent a correction opportunity, a partial correction module 88 in interval identification module 82 may determine whether the absolute value of the drift factor is greater than or equal to a maximum allowable drift threshold. The maximum allowable drift threshold is a value that indicates a maximum amount of drift that may occur prior to performing drift correction. For example, the maximum allowable drift threshold may be equal to 250 milliseconds. In this example, 250 milliseconds represent a considerable amount of drift. For instance, in accordance with the MPEG-2 standard, a 27 MHz source clock must not drift more than 30 microseconds over the course of one second. At this maximum rate of drift, it would take almost two full hours for the source clock to drift 250 milliseconds away from a clock that kept perfectly accurate time. If partial correction module 88 determines that the absolute value of the drift factor is not greater than or equal to (i.e., is less than) the maximum allowable drift threshold, partial correction module 88 may identify the correction magnitude as zero. Because the output interval is equal to one output period minus the correction magnitude, partial correction module 88, in this scenario, identifies an output interval of one output period.

On the other hand, if partial correction module 88 determines that the absolute value of the drift factor is greater than or equal to the maximum allowable drift threshold, partial correction module 88 may identify the correction magnitude as a maximum drift correction value. The maximum drift correction value is a value that is less than the drift factor. For example, the maximum drift correction value may be equal to fifteen milliseconds. Because the output interval is equal to one output period minus the correction magnitude, drift threshold module 84, in this example, identifies an output interval of one output period minus fifteen milliseconds.

After interval identification module 82 identifies the output interval, a MDU removal module 96 in post-calibration module 76 removes from input buffer 8 a set of the oldest MDUs that accounts for an amount of time equal to the output interval, as measured by output clock 14. After MDU removal module 96 removes this set of MDUs from input buffer 8, a drift correction module 90 in post-calibration module 76 may modify the set of MDUs in such a way that the set of modified MDUs accounts for a time equal to one output period, as measured by output clock 14. In order to modify the set of MDUs, drift correction module 90 may perform one or more operations that modify the times between existing ones of the MDU in the removed set of MDUs or selectively delete existing ones of the removed MDUs. Once drift correction module 90 modifies the MDUs, drift correction module 90 may provide the modified MDUs to data conversion module 28.

The way in which drift correction module 90 modifies the set of MDUs may depend on the type of media data contained in the set of MDUs. For example, the MDUs may be linear pulse code modulation audio samples. In this example, MDU removal module 96 may remove from input buffer 8 a set of audio samples that accounts for one output period minus the correction magnitude. Furthermore, in this example, drift correction module 90 includes an audio modification module 92 that modifies the removed set of audio samples in such a way that the set of modified audio samples accounts for a time equal to one output period, as measured by output clock 14.

If the set of removed audio samples accounts for a time equal to less than one output period, audio modification module 92 may then add a sufficient number of silent samples to the removed set of audio samples to make the combined set of audio samples account for a time equal to one output period, as measured by output clock 14. When played back, the silent samples may cause subscriber devices 10 to play no sound for a time interval equal to the correction magnitude. After adding the silent samples to the removed samples, audio modification module 92 may provide the combined set of audio samples to data conversion module 28. In this way, time conversion module 26 injects a period of silence that lasts for the period of the correction magnitude. If audio modification module 92 adds the silent samples to a set of audio samples that contains audible sound, the silent samples may cause a period of silence that is perceptible to a listener. However, because drift corrections generally occur at correction opportunities when there is no audible sound, this period of silence may be imperceptible to the listener. In this way, content recognition can aid in adjusting the MDUs in a manner that adjusts for drift in an unperceivable manner. When a drift correction occurs at a time other than a correction opportunity, there may be audible sound. Consequently, a listener may be able to perceive the period of silence. However, because the maximum drift correction value is less than the total drift factor, the period of silence is relatively short and might not significantly disturb the listener's experience.

On the other hand, if the set of removed audio samples accounts for a time equal to more than one output period, audio modification module 92 may delete a sufficient number of audio samples from the removed set of audio samples to make the resulting set of audio samples account for a time equal to one output period, as measured by output clock 14. After deleting the audio samples from set of removed audio samples, audio modification module 92 may provide the resulting set of audio samples to data conversion module 28. If audio modification module 92 deletes the audio samples from a set of audio samples that contains audible sound, the results may be perceptible to a listener in various ways. For example, if audio modification module 92 deletes audio samples on a periodic basis within the set of audio samples, the overall frequency of the audio sample may be greater. As a result, the listener might perceive the resulting set of audio samples has having a higher pitch than the original set of audio samples. In another example, if audio modification module 92 deletes audio samples from the beginning or end of the set of audio samples, the listener might perceive a chirp at the beginning or end of the set of audio samples due to the discontinuity between the set of audio samples and the previous or next set of audio samples. If audio modification module 92 deletes the audio samples from a set of audio samples that does not contain audible sound, the listener may not be able to perceive that audio modification module 92 has deleted any samples.

In another example, the MDUs may be video frames. In this example, MDU removal module 96 may remove from input buffer 10 a set of video frames that account for an amount of time equal to one output period minus the correction magnitude. Furthermore, in this example, drift correction module 90 includes a video modification module 94 that modifies the removed set of video frames in such a way that the modified set of video frames accounts for an amount of time equal to one output period, as measured by output clock 14.

If the set of removed video frames accounts an amount of time equal to less than one output period, video modification module 94 may modify or create timestamps on video frames in the set of removed video frames such that the timestamps instruct a decoder of the video frames to decode and present the video frames in the set of removed video frames in one output period. This may mean that there is more time between each of the video frames. For example, if each of the removed video frames is associated with a timestamp, video modification module 94 may divide the correction magnitude by the number of video frames in the set of removed video frames and then add this quotient to each of the timestamps.

Similarly, if the set of removed video frames accounts for an amount of time equal to more than one output period, video modification module 94 may modify or create timestamps on video frames in the set of removed video frames such that the timestamps instruct a decoder of the video frames to decode and present the video frames in the set of removed video frames in one output period. This may mean that there is less time between each of the video frames. Given the small amount of time involved and that no video frames are removed or added, it is unlikely that a viewer of the video frames would be able to perceive that the pacing of the video frames is different than the original pacing of the video frames.

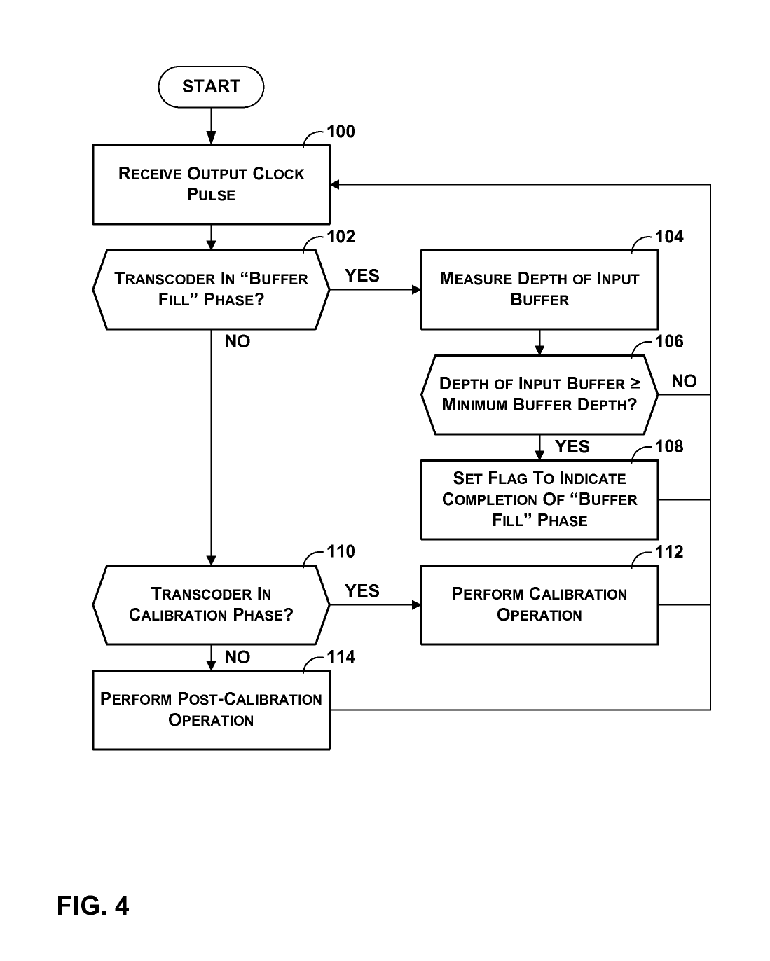

FIG. 4 is a flowchart illustrating an exemplary operation of time conversion module 26. Initially, phase identification module 70 in time conversion module 26 receives a pulse from output clock 14 (100). Phase identification module 70 may receive a pulse from output clock 14 once per output period. When phase identification module 70 receives the pulse from output clock 14, phase identification module 70 may determine whether transcoder 6 is in a “buffer fill” phase (102).

If transcoder 6 is in a “buffer fill” phase (“YES” of 102), buffer fill module 72 in time conversion module 26 may measure the current depth of input buffer 8 (104). When buffer fill module 72 measures the current depth of input buffer 8, buffer fill module 72 may calculate the current depth of input buffer 8 as the current average depth of input buffer 8. Next, buffer fill module 72 may determine whether the current depth of input buffer 8 is greater than or equal to a minimum buffer depth (106). If the current depth of input buffer 8 is greater than or equal to the minimum buffer depth (“YES” of 106), buffer fill module 72 may set a flag to indicate the completion of the “buffer fill” phase (108). If the current depth of input buffer 8 is not greater than or equal to the minimum buffer depth (“NO” of 106), the process continues with the reception of another output clock pulse (100). After buffer fill module 72 sets this flag or after buffer fill module 72 determines that the current depth of input buffer 8 is not greater than or equal to (i.e., is less than) the minimum buffer depth, time conversion module 26 loops back and waits until another pulse is received from output clock 14 (100).

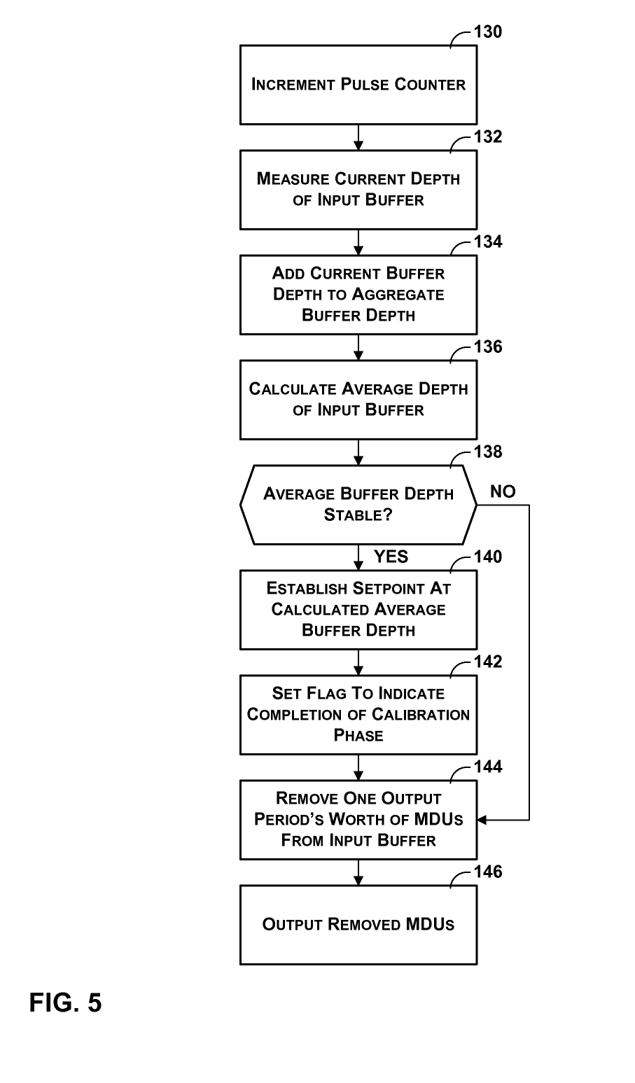

If phase identification module 70 determines that transcoder 6 is not in the “buffer fill” phase (“NO” of 102), phase identification module 70 may determine whether transcoder 6 is in a calibration phase (110). If phase identification module 70 determines that transcoder 6 is in the calibration phase (“YES” of 110), calibration module 74 may perform a calibration operation (112). An example calibration operation is described with regard to FIG. 5, below. After calibration module 74 performs the calibration operation, time conversion module 26 may again wait until another pulse is received from output clock 14 (100).

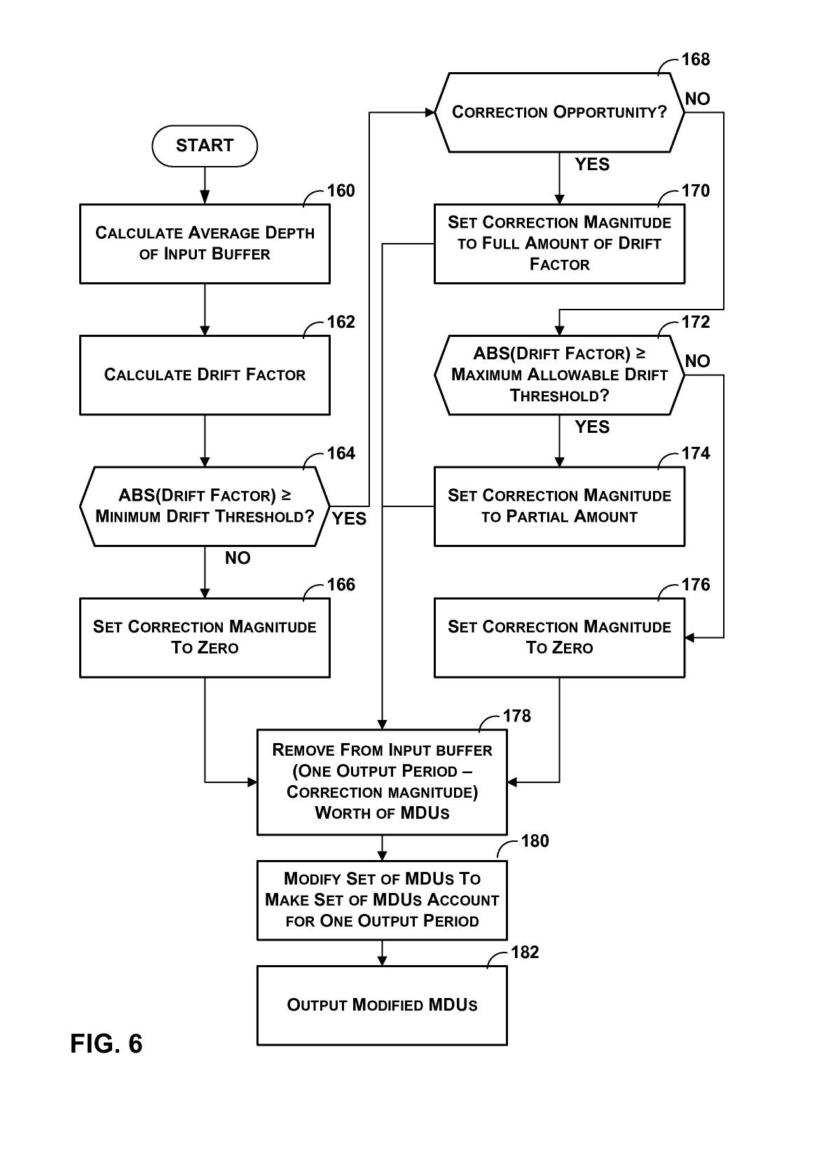

On the other hand, if phase identification module 70 determines that transcoder 6 is not in the calibration phase (“NO” of 110), post-calibration module 76 may perform a post-calibration operation (114). An example post-calibration operation is described with regard to FIG. 6, below. After post-calibration module 76 performs the calibration operation, time conversion module 26 may again wait until another pulse is received from output clock 14 (100).

FIG. 5 is a flowchart illustrating an exemplary calibration operation performed by calibration module 74 in time conversion module 26. When calibration module 74 begins a calibration operation, calibration module 74 may increment pulse counter 73 (130). Next, calibration module 74 may measure the current depth of input buffer 8 (132). After measuring the current depth of input buffer 8, calibration module 74 may update aggregate buffer depth value 75 by adding the current depth of input buffer 8 to aggregate buffer depth 75 (134). Calibration module 74 may then calculate an average depth of input buffer 8 by computing the quotient of aggregate buffer depth value 75 over pulse counter 73 (136).

After calibration module 74 calculates the average buffer depth, calibration module 74 may determine whether the average buffer depth is stable (138). Calibration module 74 may determine whether the average buffer depth is stable by determining whether the average buffer depth has changed by more than a certain percentage within a certain period of time. If calibration module 74 determines that the average buffer depth is stable (“YES” of 138), calibration module 74 may establish the setpoint at the average buffer depth (140). Next, calibration module 74 may set a flag to indicate the completion of the calibration phase (142).

After calibration module 74 sets the flag to indicate the completion of the calibration phase or after calibration module 74 determines that the average buffer depth is not stable (“NO” of 138), calibration module 74 may remove one output period's worth of MDUs from input buffer (144). Calibration module 74 may then output the removed MDUs to data conversion module 28 (146).

FIG. 6 is a flowchart illustrating an exemplary post-calibration operation of post-calibration module 76. When phase identification module 70 instructs post-calibration module 76 to perform a post-calibration operation, drift calculation module 80 in post-calibration module 76 may calculate an average depth of input buffer 8 (160). Next, drift calculation module 80 may calculate a drift factor (162). Drift calculation module 80 may, for example, calculate a drift factor by subtracting the average depth of input buffer 8 from the setpoint.

After drift calculation module 80 calculates the drift factor, drift threshold module 84 in interval identification module 82 of post-calibration module 76 may begin a process of identifying a correction magnitude by determining whether the absolute value of the drift factor is greater than or equal to the minimum drift threshold (164). If drift threshold module 84 determines that the drift factor is not greater than or equal to (i.e., is less than) the minimum drift threshold (“NO” of 164), drift threshold module 84 may set the correction magnitude to zero (166).

If drift threshold module 84 determines that the drift factor is greater than or equal to the minimum drift threshold (“YES” of 164), opportunity detection module 86 in interval identification module 82 may determine whether the oldest set of MDUs in input buffer 8 that account for an amount of time equal to one output period is associated with a correction opportunity (168). As discussed above, opportunity detection module 86 may determine that this oldest set of MDUs in input buffer constitutes a correction opportunity when the oldest set of MDUs are not associated with references to a program clock reference, when MDUs in the oldest set of MDUs are associated with discontinuous program clock references, when MDUs in the oldest set of MDUs are associated with different program map tables, when one or more consecutive MDUs correspond to audio silence and/or dark or no video, or when one or more MDUs in the oldest set of MDUs are associated with program map table revision messages. If opportunity detection module 86 determines that this oldest set of MDUs in input buffer 8 constitutes a correction opportunity (“YES” of 168), opportunity detection module 86 may set the correction magnitude equal to the full amount of the drift factor (170).

On the other hand, if opportunity detection module 86 determines that this oldest set of MDUs in input buffer 8 does not constitute a correction opportunity (“NO” of 168), partial correction module 88 in interval identification module 82 may determine whether the absolute value of the drift factor is greater than or equal to a maximum allowable drift threshold (172). If partial correction module 88 determines that the drift factor is greater than or equal to the maximum allowable drift threshold (“YES” of 172), partial correction module 88 may set the correction magnitude equal to a maximum drift correction value (174). The maximum drift correction value is a value that is less than the full drift factor. If partial correction module 88 determines that the drift factor is not greater than or equal to the maximum allowable drift threshold (“NO” of 172), partial correction module 88 may set the correction magnitude to zero (176).

After modules in interval identification module 82 identify the correction magnitude, MDU removal module 96 may remove from input buffer 8 a set of the oldest MDUs that accounts for a time equal to one output period minus the correction magnitude (178). Drift correction module 90 may then modify the set of MDUs such that the modified set of MDUs account for a time equal to one output period (180). After drift correction module 90 modifies the set of MDUs, drift correction module 90 may provide the modified MDUs to data conversion module 28 (182).

The techniques described herein may be implemented in hardware, software, firmware, or any combination thereof. Any features described as modules or components may be implemented together in an integrated logic device or separately as discrete but interoperable logic devices. If implemented in software, the techniques may be realized at least in part by a computer-readable medium comprising instructions that, when executed, performs one or more of the methods described above. The computer-readable medium may form part of a computer program product, which may include packaging materials. The computer-readable medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The code may be executed by one or more processors, such as one or more digital signal processors (DSPs), general purpose microprocessors, an application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated software modules or hardware modules configured for encoding and decoding, or incorporated in a combined video encoder-decoder (CODEC).

Various example implementations have been described. These and other implementations are within the scope of the following claims.

What is claimed is:

1. A method comprising:
storing a plurality of media data units (“MDUs”) into a buffer of a transcoder at a rate that is dependent upon a source clock of a media source;
identifying an output interval for a set of the MDUs in the buffer, wherein the output interval is dependent upon the source clock and differs from an output period by a correction magnitude, wherein the output period is dependent upon an output clock of the transcoder;
removing the set of the MDUs from the buffer, wherein an amount of time associated with the removed set of the MDUs substantially corresponds the output interval; and
modifying the set of the MDUs removed from the buffer based on content of the MDUs such that an amount of time associated with the modified set of MDUs substantially corresponds to the output period.

2. The method of claim 1, wherein modifying the set of MDUs comprises adding or deleting one or more MDUs based on content of the MDUs.

3. The method of claim 1, further comprising outputting the modified set of MDUs as part of an output media data stream.

4. The method of claim 1, wherein identifying the output interval comprises:
identifying the correction magnitude based on a current average depth of the buffer; and
identifying the output interval as a value that is equal to the output period minus the correction magnitude.

5. The method of claim 4, wherein the method further comprises:
performing calibration operations that establish a setpoint that is a measure of an average depth of the buffer during a calibration phase at the transcoder; and
calculating a drift factor that is equal to the setpoint minus a current average depth of the buffer,
wherein identifying the correction magnitude comprises identifying the correction magnitude based on the drift factor.

6. The method of claim 5, wherein performing the calibration operations comprise performing one of the calibration operations each time that the output clock indicates that the output period has passed during the calibration phase.

7. The method of claim 5, wherein identifying the correction magnitude based on the drift factor comprises:
determining whether an absolute value of the drift factor is greater than or equal to a minimum drift threshold; and
identifying the correction magnitude as zero when the absolute value of the drift factor is not greater than or equal to the minimum drift threshold.

8. The method of claim 5, wherein identifying the correction magnitude based on the drift factor comprises:
determining whether the removed set of the MDUs is associated with a correction opportunity; and
identifying the correction magnitude as the drift factor when the removed set of the MDUs is associated with a correction opportunity.

9. The method of claim 8,
wherein determining whether the removed set of the MDUs is associated with the correction opportunity comprises determining that the removed set of the MDUs is associated with the correction opportunity when at least one opportunity selected from a list of opportunities is satisfied, the list of opportunities including:
when the MDUs in the removed set of the MDUs are not associated with references to a program clock reference,
when MDUs in the removed set of the MDUs are associated with discontinuous program clock references,
when MDUs in the removed set of the MDUs are associated with different program map tables,
when one or more MDUs in the removed set of the MDUs are associated with program map table revision messages,
when one or more consecutive MDUs in the removed set of MDUs are associated with audio silence,
when one or more consecutive MDUs in the removed set of MDUs are associated with dark video, and
when one or more consecutive MDUs in the removed set of MDUs are associated with audio silence and dark video.

10. The method of claim 5, wherein identifying the correction magnitude based on the drift factor comprises:
determining whether an absolute value of the drift factor is greater than or equal to a maximum allowable drift threshold; and
identifying the correction magnitude as a maximum drift correction value when the absolute value of the drift factor is greater than or equal to the maximum allowable drift threshold,
wherein the maximum drift correction value is a value that is less than the drift factor.

11. The method of claim 1, wherein the MDUs comprise video frames.

12. The method of claim 11, wherein modifying the set of MDUs comprises modifying timestamps associated with the video frames.

13. The method of claim 1, wherein MDUs comprise audio samples.

14. The method of claim 13, wherein modifying the set of MDUs comprises deleting one or more audio samples.

15. The method of claim 13, wherein modifying the set of MDUs comprises inserting one or more audio samples.

16. The method of claim 1, wherein identifying the output interval for the set of the MDUs in the buffer comprises identifying the output interval for the set of the MDUs such that an average depth of the buffer does not fall below a buffer underflow point and does not rise above a buffer overflow point.

17. The method of claim 1, further comprising converting the MDUs from a first format into a second format, wherein the set of MDUs in the output media data stream are formatted in the second format.

18. The method of claim 17, wherein the first format is selected from a group consisting of a Moving Pictures Experts Group (MPEG) standard format, an International Telecommunication Union (ITU) H.261 standard format, an H.262 standard format, an H.263 standard format, an ITU H.264 standard format, and a serial digital interface standard format.

19. The method of claim 1, further comprising:
receiving an input multimedia data stream that includes encoded MDUs; and
generating the MDUs by decoding the encoded MDUs.

20. A transcoder device comprising:
an output clock;
a buffer capable of storing media data units (“MDUs”);
a receiving module that stores the MDUs into the buffer at a rate that is dependent upon a source clock of a media source;
an interval identification module that identifies an output interval for a set of the MDUs in the buffer, wherein the output interval is dependent upon the source clock differs from an output period by a correction magnitude, wherein the output period is dependent upon the output clock of the transcoder device;
an MDU removal module that removes the set of MDUs from the buffer, wherein an amount of time associated with the removed set of the MDUs substantially corresponds to the output interval; and
a drift correction module that modifies the set of MDUs removed from the buffer based on content of the MDUs such that an amount of time associated with the modified set the MDUs substantially corresponds to the output period.

21. The device of claim 20, wherein the drift correction module modifies the set of MDUs by adding or deleting one or more MDUs based on content of the MDUs.

22. The device of claim 20, further comprising an output module that outputs the modified set of MDUs as part of a media output stream.

23. The device of claim 20, wherein the interval identification module identifies the correction magnitude based on a current average depth of the buffer and identifies the output interval as a value that is equal to the output period minus the correction magnitude.

24. The device of claim 23,
wherein the device further comprises a calibration module that performs calibration operations that establish a setpoint that is a measure of an average depth of the buffer during a calibration phase at the transcoder device;
wherein the interval identification module comprises a drift calculation module that calculates a drift factor that is equal to the setpoint minus a current average depth of the buffer; and
wherein the interval identification module identifies the correction magnitude based on the drift factor.

25. The device of claim 24, wherein the calibration module performs one of the calibration operations each time the output clock indicates that the output period has passed during the calibration phase.

26. The device of claim 24, wherein the interval identification module comprises a drift threshold module that determines whether an absolute value of the drift factor is greater than or equal to a minimum drift threshold and identifies the correction magnitude as zero when the absolute value of the drift factor is not greater than or equal to the minimum drift threshold.

27. The device of claim 24, wherein the interval identification module comprises an opportunity detection module that determines whether the removed set of the MDUs is associated with a correction opportunity and that identifies the correction magnitude as the drift factor when the removed set of the MDUs is associated with a correction opportunity.

28. The device of claim 27,
wherein the opportunity detection module determines that the removed set of the MDUs is associated with a correction opportunity when at least one opportunity selected from a list of opportunities is satisfied, the list of opportunities including:
when the MDUs in the removed set of the MDUs are not associated with references to a program clock reference,
when MDUs in the removed set of the MDUs are associated with discontinuous program clock references,
when MDUs in the removed set of the MDUs are associated with different program map tables,
when one or more MDUs in the removed set of the MDUs are associated with program map table revision messages,
when one or more consecutive MDUs in the removed set of MDUs are associated with audio silence,
when one or more consecutive MDUs in the removed set of MDUs are associated with dark video, and
when one or more consecutive MDUs in the removed set of MDUs are associated with audio silence and dark video.

29. The device of claim 24,
wherein the interval identification module comprises a partial correction module that determines whether an absolute value of the drift factor is greater than or equal to a maximum allowable drift threshold and identifies the correction magnitude as a maximum drift correction value when the absolute value of the drift factor is greater than or equal to the maximum allowable drift threshold,
wherein the maximum drift correction value is a value that is less than the drift factor.

30. The device of claim 20, wherein MDUs comprise video frames.

31. The device of claim 30, wherein the drift correction module comprises a video modification module that modifies timestamps associated with the video frames.

32. The device of claim 20, wherein MDUs comprise audio samples.

33. The device of claim 32, wherein the drift correction module comprises an audio modification module that deletes one or more of the audio samples to create the modified set of MDUs.

34. The device of claim 32, wherein the drift correction module comprises an audio modification module that inserts one or more of the audio samples to create the modified set of MDUs.

35. The device of claim 20, wherein the interval identification module identifies the output interval for the set of the MDUs in the buffer such that an average depth of the buffer does not fall below a buffer underflow point and does not rise above a buffer overflow point.

36. The device of claim 20,
wherein the device further comprises a data conversion module that converts the MDUs from a first format into a second format; and
wherein MDUs in the output media data stream are formatted in the second format.

37. The device of claim 36, wherein the first format is selected from a group consisting of a Moving Pictures Experts Group (MPEG) standard format, an International Telecommunication Union (ITU) H.261 standard format, an H.262 standard format, an H.263 standard format, an ITU H.264 standard format, and a serial digital interface standard format.

38. The device of claim 20, wherein the receiving module receives an input multimedia data stream that includes encoded MDUs and generates the MDUs by decoding the encoded MDUs.

39. A transcoder device comprising:
means for storing a plurality of media data units (“MDUs”) into a buffer at a rate that is dependent upon a source clock of a media source;
means for identifying an output interval for a set of the MDUs in the buffer, wherein the output interval is dependent upon the source clock and differs from an output period by a correction magnitude, wherein the output period is dependent upon an output clock of the transcoder;
means for removing the set of the MDUs from the buffer, wherein an amount of time associated with the removed set of the MDUs substantially corresponds the output interval; and
means for modifying the set of the MDUs removed from the buffer based on content of the MDUs such that an amount of time associated with the modified set of MDUs substantially corresponds to the output period.

40. The device of claim 39, wherein the means for modifying the set of MDUs removed from the buffer modifies the set of MDUs by adding or deleting one or more MDUs based on content of the MDUs.

41. The device of claim 39, further comprising means for outputting the modified set of MDUs as part of an output media data stream.

42. The device of claim 39, wherein the means for identifying the output interval:
identifies the correction magnitude based on a current average depth of the buffer; and
identifies the output interval as a value that is equal to the output period minus the correction magnitude.

43. The device of claim 39, further comprising:
means for performing calibration operations that establish a setpoint that is a measure of an average depth of the buffer during a calibration phase at the transcoder; and
means for calculating a drift factor that is equal to the setpoint minus a current average depth of the buffer,
wherein the means for identifying the correction magnitude identifies the correction magnitude based on the drift factor.

44. The device of claim 43, wherein the means for performing the calibration operations performs one of the calibration operations each time that the output clock indicates that the output period has passed during the calibration phase.

45. The device of claim 43, wherein the means for identifying the correction magnitude based on the drift factor:
determines whether an absolute value of the drift factor is greater than or equal to a minimum drift threshold; and
identifies the correction magnitude as zero when the absolute value of the drift factor is not greater than or equal to the minimum drift threshold.

46. The device of claim 43, wherein the means for identifying the correction magnitude based on the drift factor:
determines whether the removed set of the MDUs is associated with a correction opportunity; and
identifies the correction magnitude as the drift factor when the removed set of the MDUs is associated with a correction opportunity.

47. The device of claim 46,
wherein the means for determining whether the removed set of the MDUs is associated with the correction opportunity comprises means for determining that the removed set of the MDUs is associated with the correction opportunity when at least one opportunity selected from a list of opportunities is satisfied, the list of opportunities including:
when the MDUs in the removed set of the MDUs are not associated with references to a program clock reference,
when MDUs in the removed set of the MDUs are associated with discontinuous program clock references,
when MDUs in the removed set of the MDUs are associated with different program map tables,
when one or more MDUs in the removed set of the MDUs are associated with program map table revision messages,
when one or more consecutive MDUs in the removed set of MDUs are associated with audio silence,
when one or more consecutive MDUs in the removed set of MDUs are associated with dark video, and
when one or more consecutive MDUs in the removed set of MDUs are associated with audio silence and dark video.

48. The device of claim 43, wherein the means for identifying the correction magnitude based on the drift factor:
determines whether an absolute value of the drift factor is greater than or equal to a maximum allowable drift threshold; and
identifies the correction magnitude as a maximum drift correction value when the absolute value of the drift factor is greater than or equal to the maximum allowable drift threshold,
wherein the maximum drift correction value is a value that is less than the drift factor.

49. The device of claim 39, wherein the MDUs comprise video frames.

50. The device of claim 49, wherein the means for modifying the set of MDUs modifies timestamps associated with the video frames.

51. The device of claim 39, wherein MDUs comprise audio samples.

52. The device of claim 51, wherein the means for modifying the set of MDUs deletes one or more audio samples.

53. The device of claim 51, wherein the mean for modifying the set of MDUs inserts one or more audio samples.

54. The device of claim 39, wherein the means for identifying the output interval for the set of the MDUs in the buffer identifies the output interval for the set of the MDUs such that an average depth of the buffer does not fall below a buffer underflow point and does not rise above a buffer overflow point.

55. The device of claim 39, further comprising means for converting the MDUs from a first format into a second format, wherein the set of MDUs in the output media data stream are formatted in the second format.

56. The device of claim 55, wherein the first format is selected from a group consisting of a Moving Pictures Experts Group (MPEG) standard format, an International Telecommunication Union (ITU) H.261 standard format, an H.262 standard format, an H.263 standard format, an ITU H.264 standard format, and a serial digital interface standard format.

57. The device of claim 39, further comprising:
means for receiving an input multimedia data stream that includes encoded MDUs; and
means for generating the MDUs by decoding the encoded MDUs.

58. A computer-readable medium comprising instructions that upon execution cause one or more processors to:
store a plurality of media data units (“MDUs”) into a buffer of a transcoder at a rate that is dependent upon a source clock of a media source;
identify an output interval for a set of the MDUs in the buffer, wherein the output interval is dependent upon the source clock and differs from an output period by a correction magnitude, wherein the output period is dependent upon an output clock of the transcoder;
remove the set of the MDUs from the buffer, wherein an amount of time associated with the removed set of the MDUs substantially corresponds the output interval; and
modify the set of the MDUs removed from the buffer based on content of the MDUs such that an amount of time associated with the modified set of MDUs substantially corresponds to the output period.

59. The computer readable medium of claim 58, wherein the instructions upon execution cause the one or more processors to modify the set of MDUs by adding or deleting one or more MDUs based on content of the MDUs.

60. The computer-readable medium of claim 58, wherein the instructions upon execution cause the one or more processors to output the modified set of MDUs as part of an output media data stream.

61. The computer-readable medium of claim 58, wherein the instructions upon execution cause the one or more processors to:
identify the correction magnitude based on a current average depth of the buffer; and
identify the output interval as a value that is equal to the output period minus the correction magnitude.

62. The computer-readable medium of claim 61, wherein the instructions upon execution cause the one or more processors to:
perform calibration operations that establish a setpoint that is a measure of an average depth of the buffer during a calibration phase at the transcoder; and
calculate a drift factor that is equal to the setpoint minus a current average depth of the buffer,
wherein identifying the correction magnitude comprises identifying the correction magnitude based on the drift factor.

63. The computer-readable medium of claim 61, wherein the instructions upon execution cause the one or more processors to perform one of the calibration operations each time that the output clock indicates that the output period has passed during the calibration phase.

64. The computer-readable medium of claim 61, wherein the instructions upon execution cause the one or more processors to:
determine whether an absolute value of the drift factor is greater than or equal to a minimum drift threshold; and
identify the correction magnitude as zero when the absolute value of the drift factor is not greater than or equal to the minimum drift threshold.

65. The computer-readable medium of claim 61, wherein the instructions upon execution cause the one or more processors to:
determine whether the removed set of the MDUs is associated with a correction opportunity; and
identify the correction magnitude as the drift factor when the removed set of the MDUs is associated with a correction opportunity.

66. The computer-readable medium of claim 65, wherein the instructions upon execution cause the one or more processors to:
determine whether the removed set of the MDUs is associated with the correction opportunity comprises determining that the removed set of the MDUs is associated with the correction opportunity when at least one opportunity selected from a list of opportunities is satisfied, the list of opportunities including:
when the MDUs in the removed set of the MDUs are not associated with references to a program clock reference,
when MDUs in the removed set of the MDUs are associated with discontinuous program clock references,
when MDUs in the removed set of the MDUs are associated with different program map tables,
when one or more MDUs in the removed set of the MDUs are associated with program map table revision messages,
when one or more consecutive MDUs in the removed set of MDUs are associated with audio silence,
when one or more consecutive MDUs in the removed set of MDUs are associated with dark video, and
when one or more consecutive MDUs in the removed set of MDUs are associated with audio silence and dark video.

67. The computer-readable medium of claim 61, wherein the instructions upon execution cause the one or more processors to:
determine whether an absolute value of the drift factor is greater than or equal to a maximum allowable drift threshold; and
identify the correction magnitude as a maximum drift correction value when the absolute value of the drift factor is greater than or equal to the maximum allowable drift threshold,
wherein the maximum drift correction value is a value that is less than the drift factor.

68. The computer-readable medium of claim 58, wherein the MDUs comprise video frames.

69. The computer-readable medium of claim 68, wherein the instructions upon execution modify the set of MDUs by modifying timestamps associated with the video frames.

70. The computer-readable medium of claim 58, wherein the MDUs comprise audio samples.

71. The computer-readable medium of claim 70, wherein the instructions upon execution cause the one or more processors to modify the set of MDUs by deleting one or more audio samples.

72. The computer-readable medium of claim 70, wherein the instructions upon execution cause the one or more processors to modify the set of MDUs by inserting one or more audio samples.

73. The computer-readable medium of claim 58, wherein the instructions upon execution cause the one or more processors to identify the output interval for the set of the MDUs such that an average depth of the buffer does not fall below a buffer underflow point and does not rise above a buffer overflow point.

74. The computer-readable medium of claim 58, wherein the instructions upon execution cause the one or more processors to convert the MDUs from a first format into a second format, wherein the set of MDUs in the output media data stream are formatted in the second format.

75. The computer-readable medium of claim 74, wherein the first format is selected from a group consisting of a Moving Pictures Experts Group (MPEG) standard format, an International Telecommunication Union (ITU) H.261 standard format, an H.262 standard format, an H.263 standard format, an ITU H.264 standard format, and a serial digital interface standard format.

76. The computer-readable medium of claim 58 wherein the instructions upon execution cause the one or more processors to:
receive an input multimedia data stream that includes encoded MDUs; and
generate the MDUs by decoding the encoded MDUs.
